(19) United States
(12) Patent Application Publication
(10) Pub. No.: US 2004/0142127 A1
(43) Pub. Date: Jul. 22, 2004

(54) Smoke-permeable polyamide-based food casing

(76) Inventors: Ulrich Delius, Frankfurt (DE); Michael Schmidt, Oestrich-Winkel (DE)

Correspondence Address: Connolly Bove Lodge & Hutz, Suite 800, 1990 M Street NW, Washington, DC, 20036-3425, US

(21) Appl. No.: 10/477,616

(22) PCT Filed: May 10, 2002
(86) PCT No.: PCT/EP02/05128

(30) Foreign Application Priority Data
May 18, 2001 (DE) 101 25 207.2

(51) Int. Cl. A22C 13/00

(52) U.S. Cl. 428/34.8

(57) ABSTRACT

The invention relates to a smoke-permeable, seamless, tubular, polyamide-based food casing, comprising a mixture consisting of an aliphatic polyamide and/or an aliphatic copolyamide, an aliphatic and/or partially aromatic polyamide and/or an aliphatic and/or partially aromatic copolyamide, which is modified with glycol or polyglycol, and a bubbling agent. The casing contains bubbles or vacuoles which distinctively improve smoke permeability. Said casing is particularly suitable as artificial casing for smoked sausages.

The present invention relates to a smoke-permeable, seamless, tubular, biaxially oriented and heat-set polyamide-based food casing. It is particularly suitable as an artificial sausage casing for smoked sausage varieties.

To produce smoked sausage goods, to date principally casings based on regenerated cellulose or collagen have been used. However, production of such casings is technically complex. For instance, cellulose casings are generally produced by the viscose process. In this process, cellulose is first converted into cellulose xanthogenate using sodium hydroxide solution and carbon disulfide (CS₂). The resultant solution, called the viscose solution, must first age for several days before it is passed into the skin-spinning machines. These machines essentially consist of a die, precipitation baths, wash baths and processing agent baths and also drying stations. In the precipitation baths the cellulose xanthogenate is regenerated to cellulose. Collagen skins, also called hide fiber skins, consist of hardened connective tissue protein. In their manufacture, first connective tissue from animal hides is mechanically comminuted and chemically digested. The homogenized mass thus formed is then further processed in a dry- or wet-spinning process. In the wet-spinning process, the collagen mass, after being extruded through an annular die, is regenerated in a coagulant precipitation bath (G. Effenberger, Wursthüllen-Kunstdarm [Sausage casings-synthetic skins], Holzmann-Buchverlag, Bad Wörishofen, 2^{nd} Edition [1991] pp. 21-27).

Cellulose and collagen casings are very readily permeable not only to smoke, but also to water vapor. The permeability is generally greater than 500 g/m²d. Owing to the high water-vapor permeability of the casing, the sausage, however, dries out undesirably if it is stored for some time.

Casings for unsmoked sausage goods are currently produced to a great extent from thermoplastics. Customary plastics are polyamides, polyesters and vinyl chloride copolymers. The casings can be produced in single-layer or multilayer form. In the multilayer casings, further layers of polyolefin may frequently be present. The decisive advantage of these casings is the technically relatively simple and inexpensive production. Casings made of thermoplastic have a water-vapor permeability (WVP) of from about 3 to 20 g/m²d. They are thus significantly less permeable than casings of regenerated cellulose or collagen. Sausage goods in such a casing therefore lose significantly less weight during storage. Casings produced from thermoplastic, for instance from polyamide, have therefore to date been generally considered as non-smoke-permeable and thus not smokable.

However, some smokable plastic casings have already been described. Thus EP-A 139 888 discloses a process for smoking foods in a casing made of aliphatic polyamide. The polyamide absorbs at least 3%, preferably at least 5%, of its weight of water. It is therefore smoked in the presence of water or steam, which requires a climatically controlled smoking cabinet.

A smokable film for packaging foods is also described in EP-A 217 069. It comprises at least one layer which consists of a mixture of polyamide, an ethylene/vinyl alcohol copolymer (EVOH) and a polyolefin, in which case the constituents of the layer must be in a defined weight ratio. The layer has a water vapor permeability of less than 40 g/m²d at a temperature of 40° C. and a relative humidity of 90%. Production of the casing is problematic. Polyamides have a high melting point. Thus, nylon 6 has a melting point of 220° C., and nylon 66 of even 260° C. The EVOH, in contrast, begins to decompose at temperatures above 200° C. In the production of film, setting the correct extrusion temperature is thus correspondingly critical.

It was thus still an object of the invention to provide a plastic casing which has a very good permeability for smoke, without special conditions (defined relative humidity, defined temperature etc.) having to be maintained during smoking. In particular smoking is to be possible under the conditions customary during production of scalded-emulsion sausage, that is to say hot smoke is to be able to be used. In addition it is to be possible to heat and smoke the scalded-emulsion sausage at the same time. Furthermore, the sausage is to be able to be produced inexpensively and simply. In particular, in the extrusion, no appearance of decomposition is to occur. The water-vapor permeability of the casing is to be significantly below 500 g/m²d, so that the food dries out as little as possible after smoking. It has now been found that the object can be achieved by a casing which is produced using a mixture which comprises aliphatic polyamide and/or aliphatic copolyamide, a glycol- or polyglycol-modified polyamide and a bubbling agent.

The present invention thus relates to a smoke-permeable, seamless, tubular, biaxially oriented and heat-set polyamide-based food casing which is a mixture comprising

at least one aliphatic polyamide and/or at least one aliphatic copolyamide,

at least one aliphatic and/or partially aromatic polyamide or at least one aliphatic and/or partially aromatic copolyamide, each of which is modified with glycol or polyglycol, and

at least one bubbling agent.

The aliphatic polyamide or copolyamide is preferably poly(ε-caprolactam), also called nylon 6, a copolyamide of hexamethylenediamine and adipic acid (=poly(hexamethylene adipamide) or nylon 66), a copolyamide of hexamethylenediamine and dodecanedioic acid (=nylon 612) or nylon 6/66. The content of the aliphatic (co)polyamide is preferably from 50 to 94% by weight, preferably from 55 to 85% by weight, particularly preferably from 60 to 80% by weight, in each case based on the total weight of the mixture.

The glycol- or polyglycol-modified polyamide or copolyamide, in a preferred embodiment, comprises

a) at least one amide moiety having units

a1) of at least bifunctional aliphatic and/or cycloaliphatic amines (especially hexameth-ylenediamine or isophoronediamine) and of at least bifunctional aliphatic and/or cycloaliphatic and/or aromatic carboxylic acids (especially adipic acid, sebacic acid, cyclohexanedicarboxylic acid, isophthalic acid or trimellitic acid), or

a2) of aliphatic aminocarboxylic acids, in particular ω-aminocarboxylic acids, or their lactams (especially ε-caprolactam or ω-lauro-lactam), or

a3) mixtures of a1) and a2) and

b) at least one glycol or polyglycol moiety having units

b1) of one at least bifunctional, aliphatic and/or cycloaliphatic alcohol having from 2 to 15 carbons, in particular from 2 to 6 carbons (especially ethylene glycol, propane-1,2-diol, propane-1,3-diol, butane-1,4-diol or trimethylolpropane) or

b2) of at least one oligo- or polyglycol of one of the alcohols specified in b1) (especially diethylene glycol, triethylene glycol, polyethylene glycol or poly(1,2-propylene glycol)) or

b3) of at least one aliphatic oligo- or polyglycol of the type specified in b2), the terminal hydroxyl groups of which are replaced by amino groups (®Jeffamine) or

b4) of a mixture of b1), b2) and/or b3) or

b5) of an ester-containing polyglycolic moiety formed from at least bifunctional aliphatic alcohols (especially ethylene glycol or 1,2-propylene glycol) and at least divalent aliphatic, cycloaliphatic and/or aromatic dicarboxylic acids (especially adipic acid, sebacic acid or isophthalic acid) or

b6) of a mixture of b1), b2) and/or b5).

Preferably, the modified polyamide, in addition to said constituents, contains no further constituents.

The polyglycolic moieties preferably each comprise from 5 to 20 glycol units, preferably from 7 to 15 glycol units, particularly preferably about 10 glycol units. Said modified (co)polyamide is accordingly preferably a block copolymer.

The content of glycol- or polyglycol-modified polyamides is generally from 5 to 49% by weight, preferably from 10 to 38% by weight, particularly preferably from 15 to 35% by weight, in each case based on the total weight of the mixture. Glycol- or polyglycol-modified polyamides are known and are described, for example, in U.S. Pat. No. 4,501,861.

The bubbling agents are particulate substances which may be classified into two groups. The first is virtually inert substances which give rise to vacuoles when the casing is extended; the second is reactive substances which, under the action of heat and/or radiation, generate a gas which causes bubbles in the film.

The first-mentioned group includes fine-grained, inorganic particles which have a relatively low adhesion to the polymers used in the casing. These are, for example, particles of calcium carbonate, barium sulfate or of iron(II) oxide. When the casing is stretched, vacuoles form around the particles.

The second group includes fine-grained, inorganic or organic materials (blowing agents) which generate carbon dioxide or other gases when they are heated or irradiated. Those which are readily suitable are, for example, sodium hydrogen carbonate, ammonium carbamate, azodicarbonamide or citric acid. Particular preference is given to blowing agents which decompose completely into gaseous products. The gases formed by the blowing agent generally produce spherical, lens-shaped or oval bubbles. Mixtures comprising one each of said inert and reactive bubbling agents can also be used. The bubbling agents are preferably used in the form of a master-batch. Suitable carrier materials for the masterbatch are, for example, polyamides (in particular aliphatic copolyamides) or a wax.

The content of bubbling agent(s) is generally from 1 to 20% by weight, preferably from 2 to 15% by weight, particularly preferably from 5 to 12% by weight, in each case based on the total weight of the mixture.

If appropriate the casing also contains customary additives, such as stabilizers, lubricants, anti-blocking pigments, inorganic or organic color pigments.

The present invention also relates to a process for producing the seamless, tubular casing. The casing is generally produced by extrusion processes which are known per se to those skilled in the art. In this case the above described mixture is melted in an extruder, plasticized and simultaneously compressed. The reactive bubbling agents can decompose already, but the resulting gases, owing to the high pressure in the extruder, cannot yet form bubbles. The melt is then extruded through an annular die. A primary tube having a relatively high wall thickness is formed. As a result of the sudden expansion after the extrusion, any gases present in the polymer material can expand and form bubbles. The primary tube is then rapidly cooled to freeze the amorphous state of the polymers. It is then reheated to the temperature required for stretching, for example about 80° C. The tube is then stretched in the longitudinal and transverse directions, which is preferably carried out in one operational step. The longitudinal stretching is customarily performed using two pinch-roll pairs having increasing drive speed; the transverse stretching is generally carried out by a gas pressure acting on the walls of the tube from the inside. The area stretch ratio (that is the product of the longitudinal stretch ratio and transverse stretch ratio) is generally from about 6 to 18, preferably from about 8 to 11.

It was surprising that at this relatively low area stretch ratio, vacuoles already form around the inert bubbling agents. Furthermore, it was unexpected that neither the inert bubbling agents, nor the reactive bubbling agents, cause bursting or tearing during stretching of the tube. The bubbles and/or vacuoles significantly increase the smoke permeability of the casing.

After the stretching, the tube is preferably additionally heat set. The desired shrink properties can be set exactly thereby. Finally, the tube is cooled, laid flat and wound up.

In a particular embodiment, the tube is then formed into a ring. For this the tube is inflated, heated unilaterally (generally in a non-contact manner by radiant heat) and then, in the heated state, curved so that it assumes a ring or spiral shape. Processes and apparatuses for forming rings are generally known to those skilled in the art and are also described in the patent literature.

In the production of the casings specified in the examples hereinafter, the following starting materials were used:

(Poly)glycol-modified polyamides (PAG):

PAG1: Copolymer based on hexamethylenediamine, adipic acid, sebacic acid and polyethylene glycol (having on average about 10 ethylene glycol units); melting point 210° C. (determined by differential scanning calorimetry, DSC), ®Grilon FE 7012 from Ems-Chemie AG.

PAG2: Copolymer based on hexamethylenediamine, adipic acid, butane-1,4-diol and diethylene glycol; melting point 166° C. (determined by DSC), BAK 402-005 from Bayer AG,

PAG3: Copolymer based on F-caprolactam and polyethylene glycol; melting point: 158° C. (determined by DSC), ®Pebax MV 1074 from Elf Atochem S.A.)

Aliphatic polyamide (PA):

PA1: Nylon 6 having a relative viscosity of 4 (measured in 96% strength sulfuric acid), ®Ultramid B4 from BASF AG,

PA2: Nylon 6/66 (weight ratio 85:15 parts by weight) having a relative viscosity of 4 (measured in 96% strength sulfuric acid), ®Ultramid C4 from BASF AG

Bubbling agents (BA):

BA1: Masterbatch of 50% by weight of very fine grained calcium carbonate and 50% by weight nylon 6 (as PA1); HT-MAB-PA 9098 from Treffert, Bingen),

BA2: Masterbatch of 25% by weight Fe₂O₃ and 75% by weight nylon 6 (as PA1); 5017-BN-72 from Wilson Color,

BA3: Wax-based masterbatch comprising sodium hydrogen carbonate and citric acid (both together 40% by weight), ®Hydrocerol 450 from Clariant Masterbatch GmbH,

percentages in the following examples are percentages by weight unless stated otherwise.

### EXAMPLE 1

A mixture of 35% PAG1, 30% PA1, 27% PA2, 4% BA1 and 4% BA2 was plasticized to form homogeneous melt in a single-screw extruder at 240° C. and extruded through an annular die at the same temperature to form a primary tube. The tube was rapidly cooled, then heated to the minimum temperature (about 70° C.) required for stretching, biaxially stretched using compressed air acting internally and then heat set in a further heating zone. The heat setting reduced the transverse stretching by about 10%. The finished casing exhibited vacuoles around the particles.

The stretch ratios of the finished food casings are summarized in table 1 hereinafter. The wall thickness of the finished casing, in this case, and in all subsequent examples and comparative examples, was 25 μm in each case.

### EXAMPLE 2

A mixture of 30% PAG1, 32% PA1, 32% PA2, 4% BA2 AND 2% BA3 was plasticized and extruded as described in example 1. Immediately after the melt left the annular die, very small sealed bubbles formed therein. The primary tube was stretched and heat set as described in example 1. The stretch parameters are summarized in table 1.

### EXAMPLE 3

A mixture of 20% PAG2, 10% PA1, 62% PA2 and 8% BA1 was processed as described in example 1 to form a biaxially stretched and heat set seamless tubular casing. After it was stretched, the casing exhibited vacuoles.

### EXAMPLE 4

A mixture of 20% PAG3, 66% PA1, 10% PA2 and 4% BA1 was processed as in example 1 to form a biaxially stretched and heat set seamless casing. This casing also exhibited vacuoles after it was stretched.

### Comparative Example 1 (Without (Poly)Glycol-modified Polyamide)

A mixture of 60% PA1, 30% PA2 and 10% BA1 was processed as described in example 1 to form a biaxially stretched and heat set seamless casing. The finished casing contained vacuoles.

### Comparative Example 2 (Without Bubbling Agent)

A mixture of 30% PAG1 and 70% PA2 was processed as described in example 1 to form a biaxially stretched and heat set seamless casing. No bubbles or vacuoles were detectable in the finished casing.

TABLE 1

| | | | | Diameter |
|---|---|---|---|---|
| | | | | of the |
| | | Total degree | Total degree | finished |
| | Primary tube | of transverse | of longitudinal | tube |
| Example | diameter [mm] | stretch | stretch | [mm] |
| 1 | 14 | 2.83 | 2.88 | 40 |
| 2 | 14 | 2.83 | 2.88 | 40 |
| 3 | 16 | 3.13 | 2.62 | 50 |
| 4 | 17 | 3.23 | 2.62 | 55 |
| C1 | 20 | 3.1 | 2.62 | 62 |
| C2 | 14 | 3.23 | 2.62 | 45 |

Table 2 below summarizes other properties of the casings.

TABLE 2

| | | Tear | Elongation at | | | | |
|---|---|---|---|---|---|---|---|
| | Water | strength)² | break)² | | | | |
| | vapor | longitudinal/ | longitudinal/ | Results of the sausage stuffing test)³ | | | |
| | permeability)¹ | transverse | transverse | | | Smoked | Smoked |
| Example | [g/m² d] | [N/mm²] | [N/mm²] | Plumpness)⁴ | Peelability)⁵ | color)⁶ | flavor)⁷ |
| 1 | 75 | 100/110 | 85/95 | 1 | 1 | 7 | 8 |
| 2 | 73 | 120/145 | 95/100 | 1 | 1 | 7 | 8 |
| 3 | 50 | 90/95 | 100/110 | 1 | 1 | 5 | 5 |
| 4 | 49 | 80/100 | 115/175 | 2 | 1 | 5 | 6 |
| C1 | 35 | 95/110 | 90/80 | 1 | 1 | 2 | 3 |
| C2 | 41 | — | — | 1 | 2 | 3 | 4 |

Table 2 shows that the sausage-meat emulsion in the inventive casings, after smoking, is significantly more deeply colored and has a more intensive smoked flavor.

Comments on the test parameters in table 2:

1) The casing was charged on one side with air having relative humidity of 85% at 23° C. The water vapor permeability was determined in accordance with DIN 53122.

2) Determined in accordance with DIN 53455 on samples soaked for 30 min and having a width of 15 mm with a clamping distance of 50 mm.

3) Casing sections soaked for 30 min then stuffed at a constant stuffing pressure with fine-grained scalded-emulsion sausage-meat emulsion and closed at the ends with metal clips. The sausages were then treated for 30 min with smoke-saturated water vapor at 75° C. in a scalding cabinet equipped with a smoke generator, then cooked for 60 min with water vapor without smoke at 80° C. The sausages were cooled to room temperature in air and then stored in a cold room at about 6° C.

4) Subjective rating on absence of creases and consistency of the sausages (1=fault-free, 3=marked crease formation).

5) Assessed how the casing unpeeled after cutting (1=fault-free; 5=sausage-meat emulsion remains entirely on the inside of the casing).

6) Measure of the brown color of the sausage-meat emulsion surface after peeling off the casing (10=very dark color, like sausages in cellulose casing; 0=no color difference from the interior of the sausage-meat emulsion).

7) Subjective rating from taste test by 4 testers (10=very strong smoked taste, like sausages in cellulose casing; 0=no smoked taste, like unsmoked scalded-emulsion sausage).

We claim:

1. A smoke-permeable, seamless, tubular, biaxially oriented and heat-set polyamide-based food casing wherein it comprises a mixture of
at least one aliphatic polyamide and/or at least one aliphatic copolyamide,
at least one aliphatic and/or partially aromatic polyamide or at least one aliphatic and/or partially aromatic copolyamide, each of which is modified with glycol or polyglycol, and
at least one bubbling agent.

2. The food casing as claimed in claim 1, wherein the aliphatic polyamide or copolyamide is nylon 6, nylon 66, nylon 612 or nylon 6/66.

3. The food casing as claimed in claim 1, wherein the content of the aliphatic (co)polyamide is from 50 to 94% by weight, preferably from 55 to 85% by weight, particularly preferably from 60 to 80% by weight, in each case based on the total weight of the mixture.

4. The food casing as claimed in one or more of claims 1 to 3, wherein the glycol- or polyglycol-modified polyamide or copolyamide comprises
a) at least one amide moiety having units
a1) of at least bifunctional aliphatic and/or cycloaliphatic amines and of at least bifunctional aliphatic and/or cycloaliphatic and/or aromatic carboxylic acids, or
a2) of aliphatic aminocarboxylic acids, in particular co-aminocarboxylic acids, or their lactams or
a3) mixtures of a1) and a2) and
b) at least one glycol or polyglycol moiety having units
b1) of one at least bifunctional, aliphatic and/or cycloaliphatic alcohol having from 2 to 15 carbons, in particular from 2 to 6 carbons or
b2) of at least one oligo- or polyglycol of one of the alcohols specified in b1) or
b3) of at least one oligo- or polyglycol of the type specified in b2), the terminal hydroxyl groups of which are replaced by amino groups or
b4) of a mixture of b1), b2) and/or b3) or
b5) of an ester-containing polyglycolic moiety formed from at least bifunctional aliphatic alcohols and at least divalent aliphatic, cycloaliphatic and/or aromatic dicarboxylic acids or
b6) of a mixture of b1), b2) and/or b5).

5. The food casing as claimed in one or more of claims 1 to 4, wherein the content of glycol- or polyglycol-modified polyamides is from 5 to 49% by weight, preferably from 10 to 38% by weight, particularly preferably from 15 to 35% by weight, in each case based on the total weight of the mixture.

6. The food casing as claimed in one or more of claims 1 to 5, wherein the bubbling agent is a virtually inert particulate substance which gives rise to vacuoles when the casing is stretched.

7. The food casing as claimed in claim 6, wherein the inert bubbling agent consists of calcium carbonate, barium sulfate or iron(m) oxide.

8. The food casing as claimed in one or more of claims 1 to 5, wherein the bubbling agent is a reactive particulate substance which, under the action of heat and/or radiation, generates a gas which gives rise to bubbles in the casing.

9. The food casing as claimed in claim 8, wherein the reactive bubbling agent consists of sodium hydrogen carbonate, ammonium carbamate, azodicarbonamide or citric acid.

10. The food casing as claimed in one or more of claims 1 to 9, wherein the content of bubbling agent(s) is from 1 to 20% by weight, preferably from 2 to 15% by weight, particularly preferably from 5 to 12% by weight, in each case based on the total weight of the mixture.

11. The food casing as claimed in one or more of claims 1 to 10, wherein it has a ring or spiral shape.

12. The food casing as claimed in claim 1 or 2, wherein it is stretched in an area stretch ratio of from 6 to 18, preferably from 8 to 11.

13. The use of the food casing as claimed in one or more of claims 1 to 12 as artificial sausage casing.
